(19) United States
(12) Patent Application Publication
(10) Pub. No.: US 2003/0231503 A1
(43) Pub. Date: Dec. 18, 2003

(54) Lighting generating optical fiber cables system

(76) Inventors: Daniel Therriault, Lac Beauport (CA); Nicolas Therriault, Lac Beauport (CA)

Correspondence Address: Mr. Daniel Therriault, 210 Chemin de la Savanne, Lac Beauport, QC, GOA 2C0, CA

(21) Appl. No.: 10/171,785

(22) Filed: Jun. 17, 2002

(51) Int. Cl. B60Q 3/00

(52) U.S. Cl. 362/464; 362/276; 362/485; 362/511

(57) ABSTRACT

The present invention is a lighting optical fiber cables system adapted to couple a trailer, trailer caravan or truck trailer to vehicle rear lights for transmit the lighting to the trailer, trailer caravan or truck trailer rear lights by means of attachment optical fiber cables.

### BACKGROUND OF THE INVENTION

1. Field of the Invention

The present invention relates to a lighting generating optical fiber cables system adapted to couple a trailer, trailer caravan or truck trailer to vehicle rear lights for transmit the lighting to the trailer, trailer caravan or truck trailer rear lights by means of attachment optical fiber cables.

2. Description of the Related Art

A search of prior art records has unveiled the following patents:

1. U.S. Pat. No. 5,363,458 issued in 1994 to Pan;

2. U.S. Pat. No. 4,167,303 issued in 1979 to Bowen;

3. U.S. Pat. No. 5,390,265 issued in 1995 to Jiao;

4. U.S. Pat. No. 5,971,578 issued in 1999 to Fohl;

5. U.S. Pat. No. 5,886,783 issued in 1999 to Shapanus;

6. U.S. Pat. No. 5,732,176 issued in 1998 to Savage;

7. U.S. Pat. No. 5,686,723 issued in 1997 to Devenyi;

8. U.S. Pat. No. 5,669,692 issued in 1997 to Thorgerson;

9. U.S. Pat. No. 5,619,194 issued in 1997 to Belfer;

10. U.S. Pat. No. 5,042,894 issued in 1991 to Swemer; and

11. CA 2,178,654 issued in 1996 to Bernasson.

As can be seen the patents above are probably the most relevant. The patent to Pan shows a cylindrical diffuser comprising an optical fiber having a proximal and a distal end; the patent to Jiao shows an optical coupler arrangement; the patent to Swemer shows a fiber optic lighting system comprising a housing; the patent to Bowen shows an improved connector assembly for joining light transmitting fiber cables to transmitter and for receiver devices and/or like cables; the patent to Bernasson shows an optical fibre with multiple point lateral illumination; the patent to Fohl shows a fiber optic light guide for a vehicle lighting system; the patent to Shapanus shows an apparatus for isolating light signals from adjacent fiber optical strands; the patent to Savage shows in combination, a tubular mounting structure having a longitudinal axis; the patent to Devenyi shows a light sensing detector assembly; the patent to Thorgerson shows a lighting system utilizing an optical fiber; and the patent to Belfer shows a fiber optic traffic signal light control system.

The proposed system shows a lighting generating optical fiber cables system adapted to couple a trailer, trailer caravan or truck trailer to vehicle rear lights for transmit the lighting to trailer, trailer caravan or truck trailer rear lights by means of attachment optical fiber cables.

### SUMMARY OF THE INVENTION

The receptive cupolas of light provided with aligned spaced holes formed therein, which are made up of an optical sensor and mounted onto the vehicle rear lights, and which are destined to pick up the lighting emitted by the vehicle rear lights for transmit the lighting to trailer rear lights by means of attachment optical fiber cables.

The mooring plungers are engaged onto the vertical members by means of attachment shown here being kingpins and nuts, which the vertical members passing through the clip members are blocked and engaged onto the horizontal members of the cupolas by means of attachment shown here being kingpins, and which are mounted to the back of vehicle, allowing the height or lenght adjustment of the cupolas according to the models and the types of vehicle.

The optical fiber cables are mounted inwardly of the cupolas and protected by the rigid sheaths, which are connected onto the sides of the trailer by the fasteners. The connecting links are engaged onto the optical fiber cables, allowing to join the optical fiber cables of the vehicle to optical fiber cables of the trailer, which are connected to trailer rear lights.

### BRIEF DESCRIPTION OF THE SEVERAL VIEWS OF THE DRAWING(S)

FIG. 1 is a perspective view of a lighting generating optical fiber cables system adapted to couple a trailer such that shown in phantom lines to vehicle rear lights for transmit the lighting to trailer rear lights by means of attachment optical fiber cables.

FIG. 2 is an exploded view of lighting generating optical fiber cables system corresponding to FIG. 1.

FIG. 3 is an exploded view of lighting generating optical fiber cables system adapted to couple a trailer to vehicle rear lights for transmit the lighting to trailer rear lights by means of attachment optical fiber cables corresponding to FIG. 1.

### DETAILED DESCRIPTION OF THE INVENTION

Referring to the drawings in more detail, it may be seen that the lighting generating optical fiber cables system (A) of the present invention is adapted to couple a trailer to vehicle rear lights for transmit the lighting to trailer rear lights by means of attachment optical fiber cables (7).

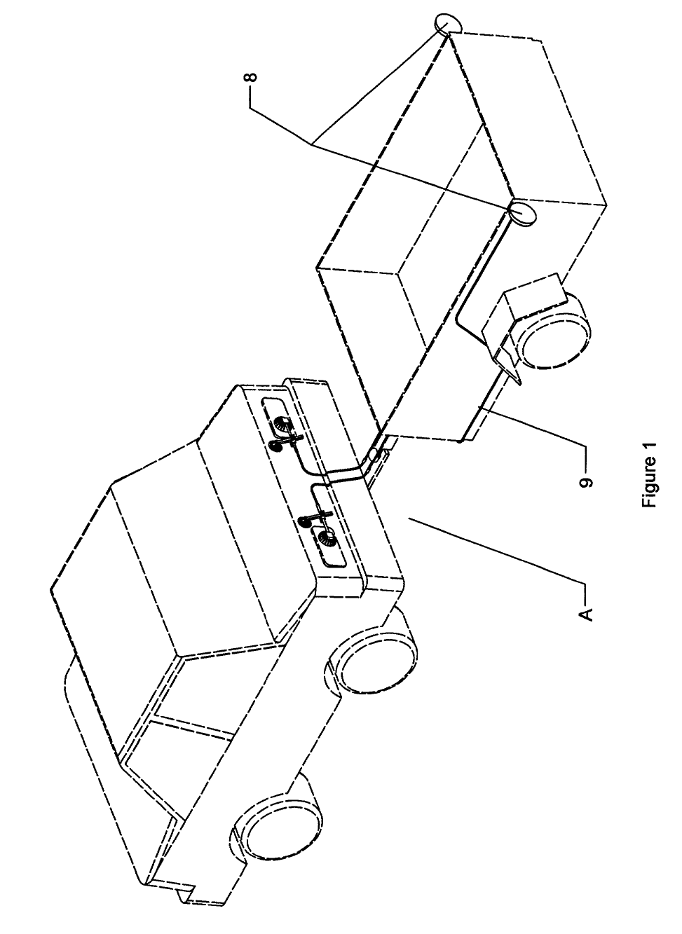

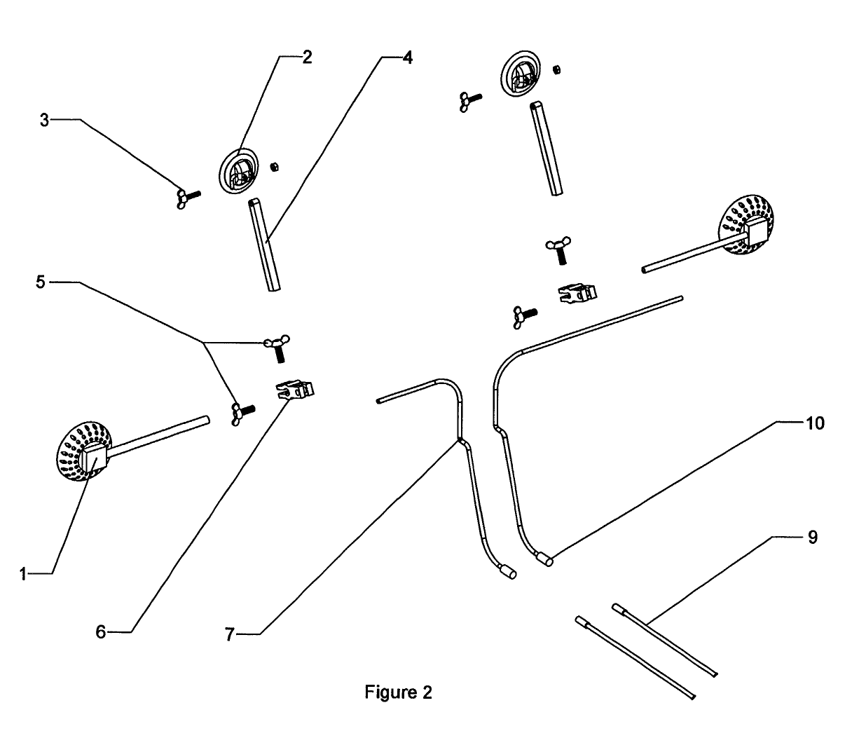

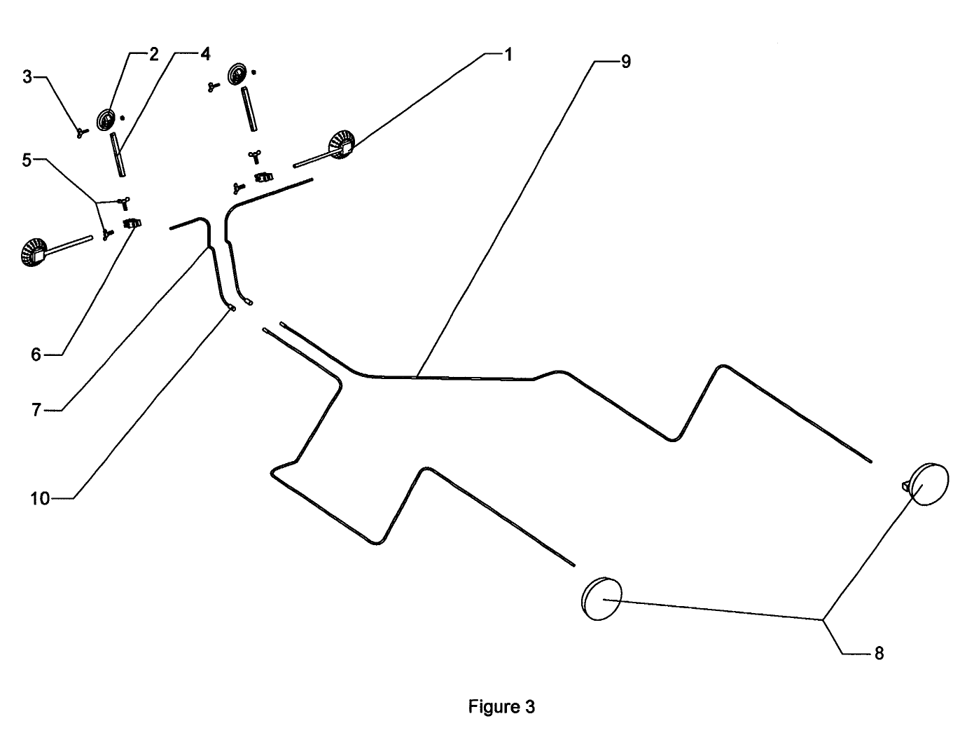

As shown in FIGS. 1, 2 and 3, the lighting generating optical fiber cables system (A) includes the receptive cupolas of light (1) provided with aligned spaced holes formed therein, which are made up of an optical sensor and mounted onto the vehicle rear lights, and which are destined to pick up the lighting emitted by the vehicle rear lights for transmit the lighting to trailer rear lights by means of attachment optical fiber cables (7).

The mooring plungers (2) are engaged onto the vertical members (4) by means of attachment shown here being kingpins (3) and nuts, which the vertical members (4) passing through the clip members (6) are blocked and engaged onto the horizontal members of the cupolas (1) by means of attachment shown here being kingpins (5), and which are mounted to the back of vehicle, allowing the height or lenght adjustment of the cupolas (1) according to the models and the types of vehicle.

The optical fiber cables (7) are mounted inwardly of the cupolas (1) and protected by the rigid sheaths, which are connected onto the sides of the trailer by the fasteners (9). The connecting links (10) are engaged onto the optical fiber cables (7), allowing to join the optical fiber cables (7) of the vehicle to optical fiber cables (7) of the trailer, which are connected to trailer rear lights.

Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

1. A lighting generating optical fiber cables system, said optical fiber cables system comprising the receptive cupolas of light provided with aligned spaced holes formed therein, which are made up of an optical sensor and mounted onto the vehicle rear lights, and which are destined to pick up the lighting emitted by said vehicle rear lights for transmit the lighting to trailer rear lights by means of attachment optical fiber cables;
the mooring plungers are engaged onto the vertical members by means of attachment shown here being kingpins and nuts, which said vertical members passing through the clip members are blocked and engaged onto the horizontal members of said cupolas by means of attachment shown here being kingpins, and which are mounted to the back of vehicle, allowing the height or lenght adjustment of said cupolas according to the models and the types of vehicle; and
said optical fiber cables are mounted inwardly of said cupolas and protected by the rigid sheaths, which are connected onto the sides of the trailer by the fasteners. The connecting links are engaged onto said optical fiber cables, allowing to join said optical fiber cables of the vehicle to said optical fiber cables of the trailer, which are connected to trailer rear lights.
